(19) United States
(12) Patent Application Publication
(10) Pub. No.: US 2022/0411295 A1
(43) Pub. Date: Dec. 29, 2022

(54) MULTIFUNCTIONAL ADDITIVE

(71) Applicant: Solugen, Inc., Houston, TX (US)

(72) Inventors: Thomas Swanson, Houston, TX (US); Jun Su An, Houston, TX (US); Paul T. Schuber, Sugar Land, TX (US); Jason Helander, Richmond, TX (US)

(73) Assignee: Solugen, Inc., Houston, TX (US)

(21) Appl. No.: 17/787,622

(22) PCT Filed: Jan. 6, 2021
(86) PCT No.: PCT/US2021/012358

§ 371 Date: Jun. 21, 2022

Related U.S. Application Data
(60) Provisional application No. 62/957,689, filed on Jan. 6, 2020.

(51) Int. Cl. C02F 1/68; B01D 21/30; B01D 21/24

(52) U.S. Cl. CPC C02F 1/683; B01D 21/30; B01D 21/24

(57) ABSTRACT

A multifunctional additive including a biochelant and a sulfide scavenger. A method of servicing a cooling tower including contacting an industrial water present in the cooling tower with an additive comprising a biochelant and a sulfide scavenger. A method of servicing a wellbore including contacting an industrial water produced from the wellbore with an additive including a biochelant and a sulfide scavenger.

### CROSS-REFERENCE TO RELATED APPLICATIONS

The present application is a 35 U.S.C. § 371 U.S. National Stage Entry application of PCT/US2021/012358 filed Jan. 6, 2021, and entitled “Multifunctional Additive,” which claims priority to U.S. Provisional Patent Application No. 62/957,689 filed Jan. 6, 2020 and entitled “Formulation to Control Hydrogen Sulfide (H₂S) and Iron-Induced Scale,” each of which is incorporated by reference herein in its entirety for all purposes.

### STATEMENT REGARDING FEDERALLY SPONSORED RESEARCH OR DEVELOPMENT

Not applicable.

### TECHNICAL FIELD

The present disclosure relates to compositions and methods for use in reducing contaminants that affect industrial water. More specifically, the present disclosure relates to a multifunctional additive for mitigating hydrogen sulfide and iron-induced scale.

### BACKGROUND

Manufacturing and other industries use water during the production process for either creating their products or cooling equipment used in creating their products. According to the United States Geological Survey (USGS), industrial water is used for fabricating, processing, washing, diluting, cooling, or transporting a product. Industries that have a high usage of water and need for treatment include sugar mills and refineries; textile manufacturing; pulp and paper mills; oil and gas; the automotive and aircraft industries and many others.

For example, cooling tower systems employ industrial water. Cooling tower systems are used to remove heat from processes or equipment. Heat removed from one medium is transferred to another medium, or process fluid, which most often is water. The driving force for the transfer of heat is the difference in temperature between the two media, which in most cooling systems is in the range of 10° F. to 200° F. Many of the properties of water, including the behavior of the contaminants it contains affect the performance of the cooling tower.

Another example is the use of water in the oil and gas industry. Water is a raw material used and produced in high quantities in the oil industry, from extraction activities through to refineries and petrochemicals. Uses for water in the oil and gas industry include as injection water, production water, process water, wastewater, rainwater, cooling water, tank-cleaning water, and others.

All industrial water contains various amounts of contaminants. These contaminants include suspended matter, which does not dissolve in water, and dissolved matter, such as minerals. These contaminants can increase process inefficiencies through numerous mechanisms such as the formation of scale, increased fouling and increased corrosion. Operations using industrial water may be interrupted in order to mitigate the level of contaminants in the water in order to prevent equipment damage. Thus, there is an ongoing need for compositions able to mitigate contaminants in industrial water.

### SUMMARY

Disclosed herein is a multifunctional additive comprising a biochelant and a sulfide scavenger.

Also disclosed herein is a method of servicing a cooling tower comprising contacting an industrial water present in the cooling tower with an additive comprising a biochelant and a sulfide scavenger.

Also disclosed herein is a method of servicing a wellbore comprising contacting an industrial water produced from the wellbore with an additive comprising a biochelant and a sulfide scavenger.

### BRIEF DESCRIPTION OF DRAWINGS

For a detailed description of the aspects of the disclosed processes and systems, reference will now be made to the accompanying drawings in which:

FIG. 1 is a process flow diagram for the wellbore operation described in Example 2.

### DETAILED DESCRIPTION

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997) can be applied, as long as that definition does not conflict with any other disclosure or definition applied herein, or render indefinite or non-enabled any claim to which that definition is applied.

Groups of elements of the periodic table are indicated using the numbering scheme indicated in the version of the periodic table of elements published in Chemical and Engineering News, 63 (5), 27, 1985. In some instances a group of elements can be indicated using a common name assigned to the group; for example alkali metals for Group 1 elements, alkaline earth metals for Group 2 elements, transition metals for Group 3-12 elements, and halogens for Group 17 elements, among others.

For any particular compound disclosed herein, the general structure or name presented is also intended to encompass all structural isomers, conformational isomers, and stereoisomers that can arise from a particular set of substituents, unless indicated otherwise. Additionally, the reference to a general structure or name encompasses all enantiomers, diastereomers, and other optical isomers whether in enantiomeric or racemic forms, as well as mixtures of stereoisomers, as the context permits or requires.

The term “substituted” when used to describe a group, for example, when referring to a substituted analog of a particular group, is intended to describe any non-hydrogen moiety that formally replaces a hydrogen in that group, and is intended to be non-limiting. A group or groups can also be referred to herein as “unsubstituted” or by equivalent terms such as “non-substituted,” which refers to the original group in which a non-hydrogen moiety does not replace a hydrogen within that group. “Substituted” is intended to be non-limiting and include inorganic substituents or organic substituents.

The terms “conduit” and “line” are interchangeable, and as used herein, refer to a physical structure configured for the flow of materials therethrough, such as pipe or tubing. The materials that flow in the “conduit” or “line” can be in a gas phase, a liquid phase, a solid phase, or a combination of these phases as usually termed “multi-phase flow.”

Regarding claim transitional terms or phrases, the transitional term “comprising”, which is synonymous with “including,” “containing,” “having,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Absent an indication to the contrary, when describing a compound or composition “consisting essentially of” is not to be construed as “comprising,” but is intended to describe the recited component that includes materials which do not significantly alter the composition or method to which the term is applied. While compositions and methods are described in terms of “comprising” various components or steps, the compositions and methods can also “consist essentially of” or “consist of” the various components or steps.

Disclosed herein are compositions for use in reducing contamination of an industrial water. Herein “industrial water” refers to water used in an industrial operation such as fabricating, processing, washing, diluting, cooling, or transporting a product; incorporating water into a product; or for sanitation needs. In an aspect, the industrial water is a feed water. Herein a feed water refers to water used in boilers and cooling towers to ensure efficiency, maximize boiler and system life, reduce maintenance costs and maintain levels of operational performance. In another aspect, the industrial water is a produced water. Herein a produced water is a term used in the oil industry to describe water that is produced as a byproduct during the extraction of oil and natural gas.

A composition of the present disclosure may be multifunctional in that it is able to (i) reduce the amount of hydrogen sulfide present in the industrial water and (ii) reduce the amount of iron-induced scale formed by contact of the industrial water with one or more equipment surfaces. In some aspects, the composition comprises a biochelant and a sulfide-scavenger and is hereinafter referred to as COMP1. In yet another aspect, the composition comprises a biochelant, a sulfide-scavenger, and a scale inhibitor and is hereinafter referred to as COMP2. In yet another aspect, the composition comprises a biochelant, a sulfide-scavenger and a corrosion inhibitor and is hereinafter referred to as COMP3. In yet another aspect, the composition comprises a biochelant, a sulfide-scavenger, a scale inhibitor and a corrosion inhibitor and is hereinafter referred to as COMP4.

In an aspect, compositions of the present disclosure comprise a chelant. Herein a chelant, also termed a sequestrant or a chelating agent, refers to a molecule capable of bonding a metal. The chelating agent is a ligand that contains two or more electron-donating groups so that more than one bond is formed between each of the atoms on the ligand to the metal. This bond can also be dative or a coordinating covalent bond meaning the electrons from each electronegative atom provides both electrons to form the bond to the metal center. In an aspect, the chelant is a biochelant. As used herein, the prefix “bio” indicates that the chemical is produced by a biological process such as using an enzyme catalyst.

In an aspect, the biochelant comprises an aldonic acid, uronic acid, aldaric acid or combination thereof and a counter cation. The counter cation may comprise an alkali metal (Group I), an alkali earth metal (Group II) or combinations thereof. In certain aspects, the counter cation is sodium, potassium, magnesium, calcium, strontium, cesium or a combination thereof.

In an aspect, the biochelant comprises a glucose oxidation product, a gluconic acid oxidation product, a gluconate or combination thereof. The glucose oxidation product, gluconic acid oxidation product or combination thereof may be buffered to a suitable pH. Buffering can be carried out using any suitable methodology such as by using a pH adjusting material in an amount of from about 1 weight percent (wt. %) to about 10 wt. %, alternatively from about 1 wt. % to about 3 wt. %, or alternatively from about 5 wt. % to about 9 wt.% based on the total weight of the biochelant. In an aspect, the biochelant comprises from about 1 wt. % to about 8 wt. % of a caustic solution in a 20 wt. % gluconate solution.

Alternatively, the biochelant comprises a buffered glucose oxidation product, a buffered gluconic acid oxidation product or combinations thereof. In such aspects, the buffered glucose oxidation product, the buffered gluconic acid oxidation product or combinations thereof are buffered to a suitable pH such as from about 6 to about 7, using any suitable acid or base such as sodium hydroxide. In such aspects, the biochelant comprises a mixture of gluconic acid and glucaric acid and further comprises a minor component species comprising n-keto-acids, C₂-C₆ diacids or combinations thereof. In an aspect, the biochelant comprises Biochelate™ metal chelation product commercially available from Solugen, Houston Tex.

In an aspect, the chelant is present in a composition of the present disclosure in an amount of from about 0.1 weight percent (wt. %) to about 40 wt. % based on the total weight of the composition, alternatively from about 0.1 wt. % to about 20 wt. % or alternatively from about 20 wt. % to about 40 wt. %.

In an aspect, a composition of the present disclosure comprises a sulfide scavenger. Any sulfide scavenger able to remove sulfide from an industrial process water and compatible with the other components of the compositions disclosed herein may be utilized. In an aspect, the sulfide scavenger is an amine-based scavenger. Amines are derivatives of ammonia in which one or more of the hydrogens has been replaced by an alkyl or aryl group.

In an aspect, the amine-based scavenger comprises a triazine generally represented by Structure I.

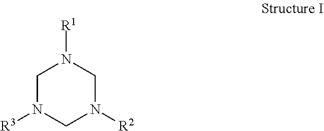

where each of R¹, R² and R³ can be the same or different. In one or more aspects, R¹, R² and R³ each independently comprise a branched C₁ to C₁₂ alkyl chain or alternatively a linear C₁ to C₁₂ alkyl chain. In another aspect, R¹, R² and R³ each independently comprise a chain of (CH₂)ₙOH and —[(CHₘ—NH], where m, n, and p are numerical values ranging from about 1 to about 12 or alternatively from about 2 to about 6. In another aspect, R¹, R² and R³ each independently comprise CH₂)ₙXₘ(CHₙ)ₙX, where n and m can be numerical values ranging from about 1 to about 12 and X is a heteroatom such as O or N.

In an aspect, R¹, R² and R³ each independently comprise amines having from 1 to 24 carbon atoms in each alkyl moiety as well as the six-membered heterocyclic amines, for example, alkyl pyridines, crude quinolones, ethylamine, diethylamine, triethylamine, propylamine, dipropylamine, propylamine, mono-, di- and tripentylamine, mono-, di- and trihexylamine and isomers of these such as isopropylamine, tertiary-butylamine, or a combination thereof. In yet another aspect, R¹, R² and R³ each independently comprise alkyl pyridines having from one to five nuclear alkyl substituents per pyridine moiety. In such aspects, the alkyl substituents comprise from about 1 to 12 carbon atoms or alternatively from about 1 to 6 carbon atoms. In an aspect, the amine-based scavenger comprises triazine. Nonlimiting examples of amine-based scavengers suitable for use in the present disclosure include MEA-triazine (monoethanoloamine), MMA-triazine (methyl methacrylate) or a combination thereof.

In an aspect, the amine-based scavenger comprises a mixture of high boiling tertiary-nitrogen-heterocyclic compounds, such as high alkyl pyridines, Reilly 10-20 base and alkyl pyridines.

In an aspect, the sulfide scavenger is present in a composition of the present disclosure in an amount of from about 0.1 weight percent (wt. %) to about 80 wt. % based on the total weight of the composition, alternatively from about 10 wt. % to about 40 wt. % or alternatively from about 50 wt. % to about 80 wt. %.

In an aspect, compositions of the present disclosure comprise a corrosion inhibitor. Any corrosion inhibitor able to inhibit corrosion of surfaces and compatible with the other components of the compositions disclosed herein may be utilized. In an aspect, the corrosion inhibitor is a cationic film-forming surfactant. Such cationic film-forming surfactants adsorb onto the surfaces resulting in an adsorption-film acting as barrier by separating the metal from the surface and blocking formation of corrosive species.

In an aspect, the cationic-film forming surfactant is selected from the group consisting of acetylenic alcohol, amines, cocoamines, amine salts, amide salts, tallow alkyl, ethoxylated alkyl amines, fatty acid amides, ethoxylated amines, phosphate esters, phosphate esters of alkyl phenyl ethoxylate, propargyl alcohol (2-propyn-1-ol), quaternary amine compounds, quaternary ammonium compounds, tall oil (Fatty acids), diethanolamine, imidazolines, fatty acid derived imidazolines, quinolones, thiazoles, triazoles, pyrazoles, derivatives thereof and combinations thereof.

In an aspect, the corrosion inhibitor is present in a composition of the present disclosure in an amount of from about 1 wt. % to about 20 wt. % based on the total weight of the composition, alternatively from about 1 wt. % to about 10 wt. % or alternatively from about 10 wt. % to about 20 wt. %.

In an aspect, compositions of the present disclosure comprise a scale inhibitor. Any scale inhibitor able to inhibit the formation of scale on surfaces and compatible with the other components of the compositions disclosed herein may be utilized.

In an aspect, the scale inhibitor comprises phosphonates, organic acids, phosphate esters, poly/orthophosphates, phosphonates polymeric organic acids, polycarboxylics, aminotrimethylene phosphonic acid (ATMP), 1-hydroxyethylidene-1,1-diphosphonic acid (HEDP), hydrolyzed polymaleic anhydride (HPMA), 2-hydrophosphonocarboxylic (HPAA), polyamino polyether phosphonate (PAPEMP), aminoethlethanolamine (AEEA), diethylenetriaminepenta-methylenephosphonic acid (DETPMP), bis(hexamethylene triamine penta (methylene phosphonic acid) (BHMT), diethylene triamine penta (methylene phosphonic acid) (BTPMP), hexamethylenediamine tetramethylene phophonic acid (HMDP), 2-phosphonobutane-1,2,4-tricarboxylic acid (PBTC), polymacrylates, maleic acid, polyaspartic acid, sodium aspartic acid, phosphinocarboxylates, acrylic acid-2-acrylamido-2-methylpropane sulfonic acid (AA-AMPS), phosphonate esters, cocamines, fatty acid amides, fatty acid-derived imidazoles, acetylenic alcohol, thiazoles, triazoles, pyrazoles, pyridine, nitrilotris (methylene) tri phosphonic acid (NTP), pentaethylene hexamineoctakis—(methylene phosphonic acid) (PEHOMP), sodiumhexamethylphospahte (SHMP), sodium tripolyphosphate (STP), tetrasodium pyrophosphate (TSPP), bis(hexamethylene triamine penta (methylene phosphonic acid) (BHMT), 1-hydroxyethylidene-1,1-diphosphonic acid (HEDP), derivatives thereof or a combination thereof. Scale inhibitors of the type disclosed herein may be in acidic form or neutralized with an appropriate base such as sodium hydroxide or ammonium salts.

In an aspect, the scale inhibitor is present in a composition of the present disclosure in an amount of from about 1 wt. % to about 20 wt. % based on the total weight of the composition, alternatively from about 1 wt. % to about 10 wt. % or alternatively from about 10 wt. % to about 20 wt. %

In an aspect, the composition optionally comprises a solvent. In some aspects, the solvent comprises C₂ to C₂₀ ethers, C₂ to C₂₀ carbonates, C₂ to C₂₀ esters, C₂ to C₂₀ ketones, C₂ to C₂₀ aldehydes, C₂ to C₂₀ alcohols or combinations thereof. Alternatively, the solvent comprises a C₂ to C₂₀ alcohol. Nonlimiting examples of alcohols suitable for use in the present disclosure include methanol, ethanol, propanol, butanol, pentanol, isopropanol, ethylene glycol, propylene glycol and combinations thereof. In an aspect, the solvent comprises water. Solvent may be present in the composition in an amount sufficient to provide a composition having suitable rheological properties to meet some user or process goal. In an aspect, the solvent is water and a composition of the present disclosure have a pH of from about 7 to about 14, alternatively from greater than about 7 to about 13 or alternatively from greater than about 7 to about 12.

In an aspect, a composition of the present disclosure, COMP1, comprises a biochelant, a sulfide scavenger and a solvent. For example, COMP1 may comprise a biochelant present in an amount of from about 0.1 wt. % to about 40 wt. %; a triazine present in an amount of from about 0.1 wt. % to about 50 wt. %; and a solvent such as water.

In an aspect, a composition of the present disclosure, COMP2, comprises a biochelant, a sulfide scavenger, a corrosion inhibitor and a solvent. For example, COMP2 may comprise a biochelant present in an amount of from about 0.1 wt. % to about 40 wt. %; a triazine present in an amount of from about 0.1 wt. % to about 50 wt. %; a corrosion inhibitor (e.g., a cationic film-forming surfactant) present in an amount of from about 1 wt. % to about 20 wt. %; and a solvent such as water.

In an aspect, a composition of the present disclosure, COMP3, comprises a biochelant, a sulfide scavenger, a scale inhibitor and a solvent. For example, COMP3 may comprise a biochelant present in an amount of from about 0.1 wt. % to about 40 wt. %; a triazine present in an amount of from about 0.1 wt. % to about 50 wt. %; a scale inhibitor (e.g., a phosphonate) present in an amount of from about 1 wt. % to about 20 wt. %; and a solvent such as water.

In an aspect, a composition of the present disclosure, COMP4, comprises a biochelant, a sulfide scavenger, a scale inhibitor, a corrosion inhibitor and a solvent. For example, COMP4 may comprise a biochelant present in an amount of from about 0.1 wt. % to about 40 wt. %; a triazine present in an amount of from about 0.1 wt. % to about 50 wt. %; a scale inhibitor (e.g., a phosphonate) present in an amount of from about 1 wt. % to about 20 wt. %; a corrosion inhibitor (e.g., a cationic film-forming surfactant) present in an amount of from about 1 wt. % to about 20 wt. %; and a solvent such as water.

Compositions of the present disclosure (e.g., COMP1) may be prepared using any suitable methodology. For example, a method of the present disclosure can comprise contacting components of the composition (e.g., a biochelant, a triazine, a phosphonate and a solvent) to form the composition. The contacting can comprise placing the components into a suitable container (e.g., a mixer, a blender, a sonicator, a bid mill, a homogenizer) to form a mixture and blending until the mixture attains some user and/or process-desired rheology.

Compositions of the present disclosure result in the effective sequestration of iron compounds and sulfide-containing materials when compared to compositions lacking a chelant of the type disclosed herein. In an aspect, compositions of the present disclosure increase the solubility of iron in an aqueous solution by from about 2 fold to about 1000 fold, alternatively greater than about 2 fold, alternatively greater than about 5 fold, alternatively greater than a 10 fold or alternatively greater than about 100 fold when compared to a composition lacking a biochelant of the type disclosed herein.

In an aspect, a composition of the type disclosed herein is formulated for use as an additive that is added to industrial water to mitigate hydrogen sulfide formation and iron-induced scale. For example, a composition of the type disclosed herein may be contacted with an industrial water present in the cooling tower. In another example, a composition of the type disclosed herein may be contacted with an industrial water, such a produced water from a wellbore servicing operation.

### EXAMPLES

The subject matter having been generally described, the following examples are given as particular aspects of the disclosure and are included to demonstrate the practice and advantages thereof, as well as aspects and features of the presently disclosed subject matter. It should be appreciated by those of skill in the art that the techniques disclosed in the examples which follow represent techniques discovered by the inventors to function well in the practice of the present subject matter, and thus can be considered to constitute preferred modes for its practice. However, those of skill in the art should, in light of the present disclosure, appreciate that many changes can be made in the specific aspects which are disclosed and still obtain a like or similar result without departing from the scope of the instant disclosure. It is understood that the examples are given by way of illustration and are not intended to limit the specification of the claims to follow in any manner.

### Example 1

The ability of a COMP of the present disclosure to inhibit the formation of iron precipitation was investigated. Specifically, a forced iron precipitation test and iron sulfide formation test was conducted. A COMP1 was prepared that contained 6.6 wt % sodium gluconate and 60 wt % MEA-triazine in an aqueous solution.

A control sample was prepared containing water, to which 5 milliliters (mL) of a concentrated 0.1 M iron (III) chloride (FeCl₃) was added, before 2 N sodium hydroxide was added until the pH reached 12. A treatment sample was prepared using 5 mL of water to which 5 mL of the concentrated iron (III) chloride (FeCl₃) was added, followed by 1 mL of the aforementioned example formulation, followed by 1 mL of a 3% sodium sulfide solution, before the 2 N sodium hydroxide was added until the pH reached 12.

The control sample was observed to have undesirable complete precipitation of iron. However, the treatment sample did not have a precipitant. The results demonstrated that COMP1 effectively chelated the dissolved iron to prevent it from precipitating. Additionally, it was recognized that, despite the presence of sulfide, the formulation was effective at preventing the formation of iron sulfide.

These results were quantified using inductively coupled plasma (ICP) analysis. Specifically, 5 mL of a 0.1M FeCl₃ solution was added to 15 ml of deionized water before the addition of of the indicated additive to form a mixture. The pH of the mixture was increased to 8 by titration with NaOH. The specific additive components are presented in Table 1. The mixture was then filtered and the filtrate analyzed by ICP. The results of this analysis is presented in Table 2.

TABLE 1

| | | Sulfide | |
|---|---|---|---|
| | Triazene | Scavenger | Chelant |
| Additive No. | (wt. %) | (wt. %) | (wt. %) |
| MEA-triazene | 40 | 0 | 0 |
| MEA-triazene and chelant | 39 | 0 | 9 |
| Sulfide Scavenger | 0 | 40 | 0 |
| 4-Sulfide Scavenger and chelant | 0 | 40 | 5 |

The triazene used was MEA-triazene, the sulfide scavenger was Sourban® PW Product which is commercially available from LONZA and the chelant was Biochelate™ metal chelation product commercially available from Solugen, Houston Tex.

TABLE 2

| | Additive Volume | Iron Concentration | |
|---|---|---|---|
| Additive | (ml) | (ppm) | pH |
| 1 | 1 | 0.03 | 8.5 |
| 2 | 1 | 1193.83 | 8.5 |
| 3 | 2.4 | 0.25 | 8.2 |
| 4 | 2.4 | 952.99 | 8.2 |

Table 2 demonstrates the presence of a chelant, as in additives 2 and 4 resulted in an increased iron concentration in the filtrate. The efficacy of the chelant in keeping iron in solution is demonstrated by the presence of high levels of iron in the filtrate in the presence of either the triazene or sulfide scavenger. The amount of solubilized iron observed when using the triazene or sulfide scavenger alone, additives 1 and 3, respectively was dramatically less.

### Example 2

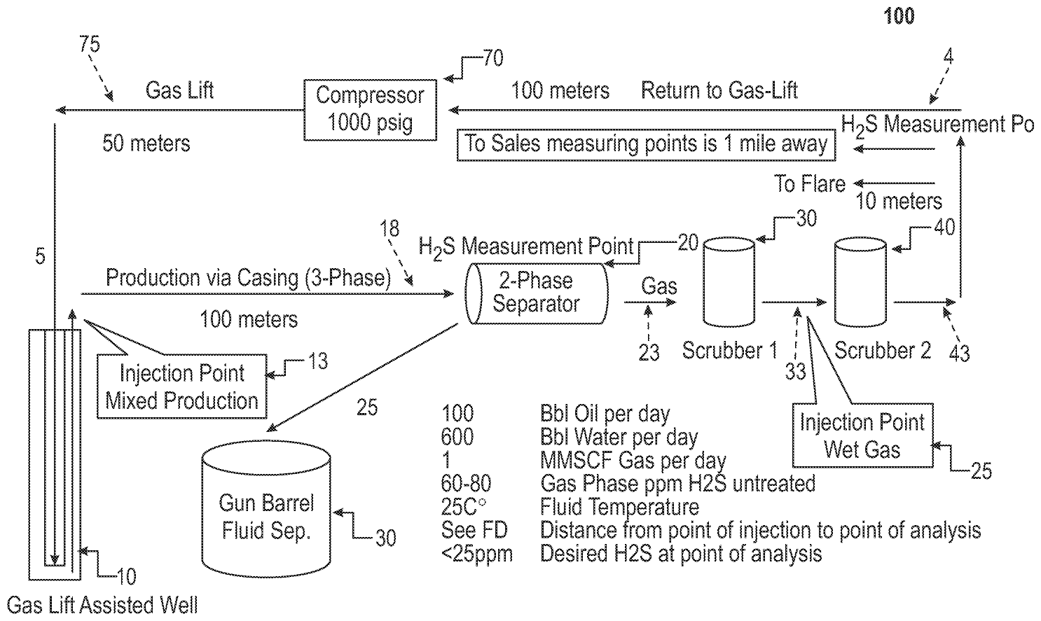

A COMP of the type disclosed herein was employed in an oil and gas well configuration of the type depicted in FIG. 1. Specifically, an oil well having a fluid temperature of 77° F. producing 1.5 MMSCFD, 600 BWPD, 100 BOPD and having from 80 ppm to 100 ppm of H₂S at a pH of 6.7 was treated with a composition of the present disclosure. The MMSFD or million standard cubic feet per day is a unit of measurement for gases that are extracted from the wellbore. The BWPD refers to the barrels of produced water the well generates per day. The BOPD refers to the barrels of oil produced by the well per day. Referring to the oil and gas well 100 depicted in FIG. 1, oil and water produced from a gas lift assisted well 10 are conveyed via a conduit 18 to a 2-phase separator 20 where at least a portion of the liquid can be conveyed via conduit 25 to a gun barrel fluid separator 30. Gas in the 2-phase separator 20 was conveyed via conduit 23 to Scrubber-1 30 and subsequently via conduit 33 to Scrubber-2 40. The material leaving Scrubber-2 40 via conduit 43 to conduit 45 may pass a H₂S measurement point 47 before being conveyed to a compressor 70 and exit via a conduit 75 to a gas lift. The results from the gas phase measurements, retention time for the separation vessels was calculated at approximately 7 hours for the bulk liquid phase and are presented in Table 3. The gas phase was estimated at 15 minutes based on the manual gas valve dump on the primary separator.

TABLE 3

| | USG/Day | Inlet | Treatment | Resulting |
|---|---|---|---|---|
| Day | H₂S cav | ppm H₂S | Location | ppm H₂S |
| 1 | 13 | 70 | Scrubber - Wet | 60 |
| | | | Gas | |
| 2 | 13 | 80 | Scrubber - Wet | 68 |
| | | | Gas | |
| 3 | 13 | 80 | Scrubber - Wet | 71 |
| | | | Gas | |
| 4 | 13 | 85 | Flowline - Mixed | 62 |
| | | | Prod. | |
| 5 | 13 | 90 | Flowline - Mixed | 55 |
| | | | Prod. | |
| 6 | 13 | 80 | Flowline & | 26 |
| | | | Atomization | |
| 7 | 13 | 85 | Flowline & | 24 |
| | | | Atomization | |
| 8 | 13 | 87 | Flowline & | 25 |
| | | | Atomization | |

The results presented in Table 3 indicate the effective reduction of hydrogen sulfide by the introduction of a COMP of the type disclosed herein.

### Additional Disclosure

The following are non-limiting, specific aspects in accordance with the present disclosure:

A first aspect which is a multifunctional additive comprising a biochelant and a sulfide scavenger.

A second aspect which is the additive of the first aspect wherein the biochelant comprises an aldonic acid, uronic acid, aldaric acid or combinations thereof.

A third aspect which is the additive of any of the first through second aspects wherein the biochelant further comprises a counter cation.

A fourth aspect which is the additive of the third aspect wherein the counter cation comprises an alkali metal, an alkali earth metal or combinations thereof.

A fifth aspect which is the additive of the third aspect wherein the counter cation comprises sodium, potassium, magnesium, calcium, strontium, cesium or combinations thereof.

A sixth aspect, which is the additive of any of the first through fifth aspects wherein the biochelant comprises a buffered glucose oxidation product, a buffered gluconic acid oxidation product or combinations thereof.

A seventh aspect which is the additive of the sixth aspect wherein the buffered glucose oxidation product, the buffered gluconic acid oxidation product or combinations thereof further comprises n-keto-acids, C₂-C₆ diacids or combinations thereof.

An eighth aspect which is the additive of any of the first through seventh aspects wherein the biochelant is present in an amount of from about 1 wt. % to about 40 wt. % based on the total weight of the additive.

A ninth aspect which is the additive of any of the first through eighth aspects wherein the sulfide scavenger comprises an amine-based scavenger.

A tenth aspect which is the additive of the ninth aspect wherein the amine-based scavenger is a triazine generally represented by Structure I.

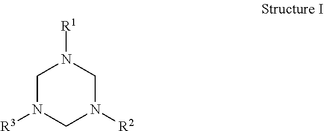

where each of R¹, R² and R³ can be the same or different. In one or more aspects, R¹, R² and R³ each independently comprise a branched C₁ to C₁₂ alkyl chain or alternatively a linear C₁ to C₁₂ alkyl chain.

An eleventh aspect which is the additive of the tenth aspect wherein R¹, R² and R³ each independently comprise a chain of (CH₂)ₙOH and —[(CHₘ—NH], where m, n, and p are numerical values ranging from about 1 to about 12.

A twelfth aspect which is additive of the tenth aspect wherein R¹, R² and R³ each independently comprise CH₂)ₙXₘ(CHₙ)ₙX, where n and m can be numerical values ranging from about 1 to about 12 and X is a heteroatom.

A thirteenth aspect which is the additive of the tenth aspect wherein R¹, R² and R³ each independently comprise amines having from 1 to 24 carbon atoms.

A fourteenth aspect which is the additive of the tenth aspect wherein R¹, R² and R³ each independently comprise alkyl pyridines having from one to five nuclear alkyl substituents per pyridine moiety.

A fifteenth aspect which is the additive of any of the first through fourteenth aspects wherein the sulfide scavenger comprises MEA-triazine (monoethanoloamine), MMA-triazine (methyl methacrylate) or a combination thereof.

A sixteenth aspect which is the additive of any of the first through fifteenth aspects wherein the sulfide scavenger is present in an amount of from about 0.1 weight percent (wt. %) to about 50 wt. % based on the total weight of the additive.

A seventeenth aspect which is the additive of any of the first through sixteenth aspects further comprising a corrosion inhibitor.

An eighteenth aspect which is the additive of the seventeenth aspect wherein the corrosion inhibitor comprises a cationic film-forming surfactant.

A nineteenth aspect which is the additive of the eighteenth aspect wherein the cationic-film forming surfactant is selected from the group consisting of acetylenic alcohol, amines, cocoamines, amine salts, amide salts, tallow alkyl, ethoxylated alkyl amines, fatty acid amides, ethoxylated amines, phosphate esters, phosphate esters of alkyl phenyl ethoxylate, propargyl alcoho, quaternary amine compounds, quaternary ammonium compounds, tall oil, diethanolamine, imidazolines, fatty acid derived imidazolines, quinolones, thiazoles, triazole, pyrazoles, derivatives thereof and combinations thereof.

A twentieth aspect which is the additive of any of the seventeenth through nineteenth aspects wherein the corrosion inhibitor is present in an amount of from about 1 wt. % to about 20 wt. % based on the total weight of the additive.

A twenty-first aspect which is the additive of any of the first through twentieth aspects further comprising a scale inhibitor.

A twenty-second aspect which is the additive of the twenty-first aspect wherein the scale inhibitor comprises organic acids, phosphate esters, poly/orthophosphates, phosphonates polymeric organic acids, polycarboxylics, aminotrimethylene phosphonic acid (ATMP), 1-hydroxyethylidene-1,1-diphosphonic acid (HEDP), hydrolyzed polymaleic anhydride (HPMA), 2-hydrophosphonocarboxylic (HPAA), polyamino polyether phosphonate (PAPEMP), aminoethlethanolamine (AEEA), diethylenetriaminepenta-methylenephosphonic acid (DETPMP), bis(hexamethylene triamine penta (methylene phosphonic acid) (BHMT), diethylene triamine penta (methylene phosphonic acid) (BTPMP), hexamethylenediamine tetramethylene phophonic acid (HMDP), 2-phosphonobutane-1,2,4-tricarboxylic acid (PBTC), polymacrylates, maleic acid, polyaspartic acid, sodium aspartic acid, phosphinocarboxylates, acrylic acid-2-acrylamido-2-methylpropane sulfonic acid (AA-AMPS), phosphonate esters, cocamines, fatty acid amides, fatty acid-derived imidazoles, acetylenic alcohol, thiazoles, triazoles, pyrazoles, pyridine, nitrilotris (methylene) tri phosphonic acid (NTP), pentaethylene hexamineoctakis—(methylene phosphonic acid) (PEHOMP), sodiumhexamethylphosphate (SHMP), sodium tripolyphosphate (STP), tetrasodium pyrophosphate (TSPP), bis(hexamethylene triamine penta (methylene phosphonic acid) (BHMT), 1-hydroxyethylidene-1,1-diphosphonic acid (HEDP), derivatives thereof or any combinations thereof.

A twenty-third aspect which is the additive of any of twenty-first through twenty-second aspects wherein the scale inhibitor is present in an amount of from about 1 wt. % to about 20 wt. % based on the total weight of the additive.

A twenty-fourth aspect which is the additive of any of the first through twenty-third aspects further comprising a solvent.

A twenty-fifth aspect which is the additive of the twenty-fourth aspect wherein the solvent comprises water, methanol, ethanol, propanol, butanol, pentanol, isopropanol, ethylene glycol, propylene glycol or combinations thereof.

A twenty-sixth aspect which is a method of servicing a cooling tower comprising contacting an industrial water present in the cooling tower with an additive comprising a biochelant and a sulfide scavenger.

A twenty-seventh aspect which is a method of servicing a wellbore comprising contacting an industrial water produced from the wellbore with an additive comprising a biochelant and a sulfide scavenger.

While aspects of the disclosure have been shown and described, modifications thereof can be made without departing from the spirit and teachings of the presently disclosed subject matter. The aspects and examples described herein are exemplary only, and are not intended to be limiting. Many variations and modifications of the subject matter disclosed herein are possible and are within the scope of the present disclosure.

At least one aspect is disclosed and variations, combinations, and/or modifications of the aspect(s) and/or features of the aspect(s) made by a person having ordinary skill in the art are within the scope of the disclosure. Alternative aspects that result from combining, integrating, and/or omitting features of the aspect(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, 5, 6, . . . ; greater than 0.10 includes 0.11, 0.12, 0.13, 0.14, 0.15, . . . ). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent . . . 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of.

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the detailed description of the presently disclosed subject matter.

1. A multifunctional additive comprising a biochelant and a sulfide scavenger.

2. The additive of claim 1, wherein the biochelant comprises an aldonic acid, uronic acid, aldaric acid or combinations thereof.

3. The additive of claim 1, wherein the biochelant further comprises a counter cation.

4. The additive of claim 3, wherein the counter cation comprises an alkali metal, an alkali earth metal or combinations thereof.

5. The additive of claim 3, wherein the counter cation comprises sodium, potassium, magnesium, calcium, strontium, cesium or combinations thereof

6. The additive of claim 1, wherein the biochelant comprises a buffered glucose oxidation product, a buffered gluconic acid oxidation product or combinations thereof.

7. The additive of claim 6, wherein the buffered glucose oxidation product, the buffered gluconic acid oxidation product or combinations thereof further comprises n-keto-acids, C₂-C₆ diacids or combinations thereof.

8. The additive of claim 1, wherein the biochelant is present in an amount of from about 1 wt. % to about 40 wt. % based on the total weight of the additive.

9. The additive of claim 1, wherein the sulfide scavenger comprises an amine-based scavenger.

10. The additive of claim 9, wherein the amine-based scavenger is a triazine generally represented by Structure I. 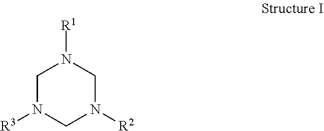
where each of R¹, R² and R³ can be the same or different. In one or more aspects, R¹, R² and R³ each independently comprise a branched C₁ to C₁₂ alkyl chain or alternatively a linear C₁ to C₁₂ alkyl chain.

11. The additive of claim 10, wherein R¹, R² and R³ each independently comprise a chain of (CH₂)ₙOH and —[(CHₘ—NH], where m, n, and p are numerical values ranging from about 1 to about 12.

12. The additive of claim 10, wherein R¹, R² and R³ each independently comprise CH₂)ₙXₘ(CHₙ)ₙX, where n and m can be numerical values ranging from about 1 to about 12 and X is a heteroatom.

13. The additive of claim 10, wherein R¹, R² and R³ each independently comprise amines having from 1 to 24 carbon atoms.

14. The additive of claim 10, wherein R¹, R² and R³ each independently comprise alkyl pyridines having from one to five nuclear alkyl substituents per pyridine moiety.

15. The additive of claim 1, wherein the sulfide scavenger comprises MEA-triazine (monoethanoloamine), MMA-triazine (methyl methacrylate) or a combination thereof.

16. The additive of claim 1, wherein the sulfide scavenger is present in an amount of from about 0.1 weight percent (wt. %) to about 50 wt. % based on the total weight of the additive.

17. The additive of claim 1, further comprising a corrosion inhibitor.

18. The additive of claim 17, wherein the corrosion inhibitor comprises a cationic film-forming surfactant.

19. The additive of claim 18, wherein the cationic-film forming surfactant is selected from the group consisting of acetylenic alcohol, amines, cocoamines, amine salts, amide salts, tallow alkyl, ethoxylated alkyl amines, fatty acid amides, ethoxylated amines, phosphate esters, phosphate esters of alkyl phenyl ethoxylate, propargyl alcoho, quaternary amine compounds, quaternary ammonium compounds, tall oil, diethanolamine, imidazolines, fatty acid derived imidazolines, quinolones, thiazoles, triazole, pyrazoles, derivatives thereof and combinations thereof.

20. The additive of claim 17, wherein the corrosion inhibitor is present in an amount of from about 1 wt. % to about 20 wt. % based on the total weight of the additive.

21. The additive of claim 1, further comprising a scale inhibitor.

22. The additive of claim 21, wherein the scale inhibitor comprises organic acids, phosphate esters, poly/orthophosphates, phosphonates polymeric organic acids, polycarboxylics, aminotrimethylene phosphonic acid (ATMP), 1-hydroxyethylidene-1,1-diphosphonic acid (HEDP), hydrolyzed polymaleic anhydride (HPMA), 2-hydrophosphonocarboxylic (HPAA), polyamino polyether phosphonate (PAPEMP), aminoethlethanolamine (AEEA), diethylenetriaminepenta-methylenephosphonic acid (DETPMP), bis(hexamethylene triamine penta (methylene phosphonic acid) (BHMT), diethylene triamine penta (methylene phosphonic acid) (BTPMP), hexamethylenediamine tetramethylene phophonic acid (HMDP), 2-phosphonobutane-1,2,4-tricarboxylic acid (PBTC), polymacrylates, maleic acid, polyaspartic acid, sodium aspartic acid, phosphinocarboxylates, acrylic acid-2-acrylamido-2-methylpropane sulfonic acid (AA-AMPS), phosphonate esters, cocamines, fatty acid amides, fatty acid-derived imidazoles, acetylenic alcohol, thiazoles, triazoles, pyrazoles, pyridine, nitrilotris (methylene) tri phosphonic acid (NTP), pentaethylene hexamineoctakis—(methylene phosphonic acid) (PEHOMP), sodiumhexamethylphosphate (SHMP), sodium tripolyphosphate (STP), tetrasodium pyrophosphate (TSPP), bis(hexamethylene triamine penta (methylene phosphonic acid) (BHMT), 1-hydroxyethylidene-1,1-diphosphonic acid (HEDP), derivatives thereof or any combinations thereof.

23. The additive of claim 21, wherein the scale inhibitor is present in an amount of from about 1 wt. % to about 20 wt. % based on the total weight of the additive.

24. The additive of claim 1, further comprising a solvent.

25. The additive of claim 24, wherein the solvent comprises water, methanol, ethanol, propanol, butanol, pentanol, isopropanol, ethylene glycol, propylene glycol or combinations thereof.

26. A method of servicing a cooling tower comprising contacting an industrial water present in the cooling tower with an additive comprising a biochelant and a sulfide scavenger.

27. A method of servicing a wellbore comprising contacting an industrial water produced from the wellbore with an additive comprising a biochelant and a sulfide scavenger.
